(19) United States
(12) Patent Application Publication
(10) Pub. No.: US 2014/0352645 A1
(43) Pub. Date: Dec. 4, 2014

(54) CYLINDER LINER AND CYLINDER HEAD FOR COMBUSTION ENGINE

(71) Applicant: CATERPILLAR MOTOREN GMBH & CO. KG, KIEL (DE)

(72) Inventors: Sascha Burkhard, Kronhagen (DE); Volker Abaraham, Kiel (DE); Frank Witt, Bordesholm (DE); Heiko Sattler, Kiel (DE)

(21) Appl. No.: 14/362,734

(22) PCT Filed: Dec. 14, 2012
(86) PCT No.: PCT/EP2012/005173

§ 371 Date: Jun. 4, 2014

(30) Foreign Application Priority Data
Dec. 16, 2011 (EP) 11193983.1

(51) Int. Cl. F02F 1/00

(52) U.S. Cl. CPC F02F 1/004
USPC 123/193.3

(57) ABSTRACT

A cylinder liner for being mounted to a cylinder head of an internal combustion engine includes an inner liner face for guiding a piston of the internal combustion engine, an outer liner face, and a liner end face facing the cylinder head in a mounted state and connecting the inner liner face and the outer liner face. The inner liner face extends along a cylinder axis of the cylinder liner. The liner end face includes a sealing groove for holding a joint ring and a step-like structure formed in a liner wall of the cylinder liner. The step-like structure includes in series a first radially extending liner face, a first axially extending liner face, a second radially extending liner face, a second axially extending liner face, a third radially extending liner face, and a transition liner face.

### TECHNICAL FIELD

The present disclosure generally refers to a cylinder unit of an internal combustion engine and more particularly to a cylinder liner and a cylinder head.

### BACKGROUND

Large internal combustion engines may comprise separate cylinder units, each cylinder unit comprising a cylinder head and cylinder liner that are configured as individual parts for each cylinder unit. For large internal combustion engines, cylinder liner/cylinder head configurations are known in which the cylinder liner and the cylinder head are mounted in combination with a coolant jacket to an engine block. The water jacket forms a coolant circulation space for cooling the cylinder liner at the cylinder head side as well as the cylinder head and the injection system mounted thereto. The coolant circulation space is sealed via O-rings with respect to the cylinder head, cylinder liner, and the interface between the cylinder head and cylinder liner. Specifically, an O-ring is positioned between the cylinder head and the coolant jacket, the cylinder liner and the coolant jacket as well as between the cylinder head and the cylinder liner. In particular, the O-ring between the cylinder head and the coolant jacket additionally provides for a relative positioning between the cylinder liner and the cylinder head

For various types of engines, U.S. Pat. No. 3,942,807, U.S. Pat. No. 5,033,426, and U.S. Pat. No. 4,399,783 disclose exemplarily cylinder liner/cylinder head configurations in which cylinder heads are directly mounted to cylinder liners, thereby providing a tight seal. Moreover, U.S. Pat. No. 3,843,141 discloses a shoulder for centering a cylinder head and U.S. Pat. No. 4,436,061 discloses, for an automotive engine, projections for aligning a cylinder head with a water jacket wall.

The present disclosure is directed, at least in part, to improving or overcoming one or more aspects of prior systems.

### SUMMARY OF THE DISCLOSURE

According to an aspect of the present disclosure, a cylinder liner for being mounted to a cylinder head of an internal combustion engine comprises an inner liner face for guiding a piston of the internal combustion engine, wherein the inner liner face extends along a cylinder axis of the cylinder liner, an outer liner face, and a liner end face facing the cylinder head in the mounted state and connecting the inner liner face and the outer liner face. The liner end face includes a sealing groove for holding a joint ring and a step-like structure formed in a liner wall of the cylinder liner, wherein the step-like structure comprises in series a first radially extending liner face next to the sealing groove, a first axially extending liner face for centering the cylinder liner in the mounted state with respect to the cylinder head, the first axially extending liner face facing in radial direction away from the cylinder axis, a second radially extending liner face, a second axially extending liner face for positioning an O-ring, a third radially extending liner face, and a transition liner face connecting the third radially extending liner face with the outer liner face.

According to another aspect of the present disclosure, a cylinder head for connecting to a cylinder liner of an internal combustion engine comprises a cylinder head body having a combustion zone face delimiting a combustion zone and a ring face, which surrounds the combustion zone face and faces in the mounted state towards the cylinder liner, for example, in direction of a cylinder axis of the cylinder head, wherein the ring face includes a cylinder head sealing area for contacting in the mounted state a joint ring and a step-like counter-structure. The step-like counter-structure comprises in series a first radially extending cylinder head face next to the head sealing area, a first axially extending cylinder head face for centering the liner in the mounted state with respect to the cylinder head, the first axially extending cylinder head face facing in radial direction towards the cylinder axis, a second radially extending cylinder head face for contacting an O-ring in the mounted state, and a border enhancement at the periphery of the ring face that extends beyond the combustion zone face further than a mounted injection nozzle extends beyond the combustion zone face.

According to another aspect of the present disclosure, an internal combustion engine comprises an engine block, a cylinder liner as, for example, indicated above, the cylinder liner having a first axially extending liner face for centering the liner in the mounted state, a cylinder head as, for example, indicated above, the cylinder head having a first axially extending cylinder head face for interacting with the first axially extending liner face and centering the liner in the mounted state with respect to the cylinder head, a joint ring for providing for a radial sealing between the cylinder liner and the cylinder head, and a coolant jacket configured to surround the cylinder liner and the cylinder head and to form a coolant circulation space between the coolant jacket and the cylinder liner and the cylinder head. The cylinder head and the coolant jacket comprise though holes for bolts and the cylinder head is screwed to the engine block via bolts in the through holes, thereby pressing the joint ring and the cylinder liner towards the engine block and providing a gas sealing between the cylinder liner and the cylinder head, whereby a translational movement of the cylinder liner with respect to the cylinder head is limited through the first axially extending liner face and the first axially extending cylinder head face.

Other features and aspects of this disclosure will be apparent from the following description and the accompanying drawings.

### BRIEF DESCRIPTION OF THE DRAWINGS

FIG. 1 is a schematic cut view of a cylinder unit of a large internal combustion engine; and

FIG. 2 is schematic cut view of the enlarged interface region between the cylinder head and the cylinder liner of FIG. 1.

### DETAILED DESCRIPTION

The following is a detailed description of exemplary embodiments of the present disclosure. The exemplary embodiments described therein and illustrated in the drawings are intended to teach the principles of the present disclosure, enabling those of ordinary skill in the art to implement and use the present disclosure in many different environments and for many different applications. Therefore, the exemplary embodiments are not intended to be, and should not be considered as, a limiting description of the scope of patent protection. Rather, the scope of patent protection shall be defined by the appended claims.

The present disclosure may be based in part on the realization that, during the operation of large internal combustion engines, the elasticity of the O-rings may allow a relative motion between the cylinder head, the cylinder liner, and/or the coolant ring and that such an allowed relative motion may affect the O-ring sealing capability in long term. In addition, the O-ring between the cylinder head and the cylinder liner may be subjected to increased temperatures and, thereby, further lose sealing capacity. Moreover, when servicing the cylinder unit, e.g. to check the piston during regular maintenance the cylinder head is removed with the injection nozzle being mounted therein. In view of these aspects, the disclosure relates to a cylinder head/cylinder liner interface that may reduce the wear and tear of O-rings and further may protect the injection nozzle when storing the cylinder head with the injection nozzle being mounted therein.

The disclosed cylinder head/cylinder liner interface may provide for a tight sealing between the cylinder liner and the cylinder head in the mounted state. Specifically, a sealing surface may be provided for the cylinder liner on a liner end face, which faces in the mounted state towards the cylinder head. The sealing surface may, for example, be positioned within a sealing groove. For the cylinder head, a sealing surface may be provided on a ring face of the cylinder head, which may surround a combustion zone face of the cylinder head and face in the mounted state towards the liner end face. The sealing surfaces may be pressed to opposing ends of a joint ring, thereby forming a gas tight seal of the combustion chamber.

The cylinder head/cylinder liner interface may further provide a step-like structure that evolves from the sealing groove radially to the outside. The step-like structure may comprise a pair of centering surfaces at the cylinder head and the cylinder liner, whereby the centering surfaces may extend in direction of the cylinder axis.

The step-like structure may comprise an O-ring holding structure, e.g. an axially extending concave curved face for holding a coolant sealing O-ring and a border enhancement at the cylinder head. The step-like structure may further comprise a circular opening for coolant to be able to pass by the O-ring. The circular opening may be formed between a transition face of the cylinder liner and the border enhancement of the cylinder head at the periphery of the ring face.

To provide a protection of the nozzle system in a demounted state of the cylinder head, the border enhancement may extend beyond the combustion zone face further than the mounted injection nozzle extends beyond the combustion zone face. Accordingly, the cylinder head may be positioned, e.g., on a flat surface without the danger that the sealing surfaces as well as the injection nozzle may be contacted or even damaged by some support surface.

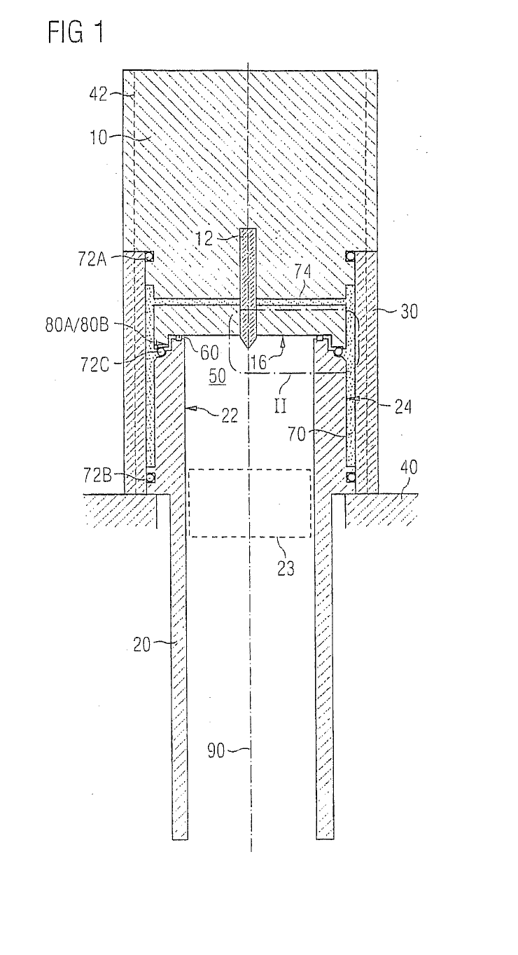

FIG. 1 shows an exemplary schematic embodiment of a cylinder liner/cylinder head configuration comprising a cylinder head 10 with an injection nozzle system 12, a cylinder liner 20, and a coolant jacket 30, which may be screwed to an engine block 40 using, for example, bolts and cylinder head units (not shown) and through holes 42 within cylinder head and coolant jacket 30.

A combustion zone 50 within the upper part of cylinder liner 20 may be sealed by a joint ring 60 to avoid any leakage of gases out of combustion zone 50.

A coolant circulation space 70 may be limited by sealing O-rings, specifically an upper O-ring 72A being positioned between cylinder head 10 and coolant jacket 30, an lower O-ring 72B being positioned between cylinder liner 20 and coolant jacket 30 as well as and a central O-ring 72C being positioned between cylinder head 10 and cylinder liner 20.

In addition, a cooling channel system 74 within cylinder head 10 may be connected with coolant circulation space 70 and provide cooling of injection nozzle system 12.

Joint ring 60 may provide for a radial sealing, thus, in principle allowing a radial (micro-) motion of cylinder head 10 with respect to cylinder liner 20. To avoid or at least reduce such a radial motion during operation, cylinder head 10 may be configured to be guided by a pair of centering surfaces 80A and 80B extending along the direction of a cylinder axis 90 on the cylinder liner 20 and cylinder head 10, respectively. The disclosed cylinder unit may provide for a cylinder liner/cylinder head interface configuration that may improve the centering of the cylinder liner with respect to the cylinder head, in particular during operation of the engine. In addition, the configuration may position center sealing O-ring 72C further away from combustion zone 50, thus, the O-ring being at a lower temperature and having an improved thermal contact to the circulating coolant. In addition, the configuration may protect injection nozzle system 12 in the demounted state of cylinder head 10.

In contrast to a configuration, in which an O-ring between cylinder head 10 and coolant jacket 30 may provide for the centering a cylinder liner with respect to a cylinder head e.g. (e.g. via a cooling water jacket), centering surfaces 80A and 80B may provide a radial more restricted centering of cylinder head 10 with respect to cylinder liner 20.

In some embodiments, the proposed surface based centering may be based on a pair of opposing metallic centering faces at both, cylinder head 10 and cylinder liner 20. For example, liner centering face 80A may be configured to surround the cylinder axis and face radially away from a cylinder axis 90 while opposing head centering face 80B may be configured to surround the cylinder axis and face radially inward to cylinder axis 90. The metallic surface based centering may allow a precise and tight positioning of cylinder head 10 with respect to cylinder liner 20.

In some embodiments, the centering surfaces may intersect with the direction of the cylinder axis, for example, in an angle range from 2° to 5°.

The radial play between the two surfaces may reduce the relative motion of the cylinder head with respect to the coolant jacket and cylinder liner and, thereby, the related potential leaking of cooling water due to the wear and tear of the O-ring seals for the coolant system. In the cool down state of the engine, a clearance ΔR of about 0.3 mm to 0.5 mm in radial direction of centering surfaces 80A and 80B may provide for sufficient alignment during operation such that a relative motion between cylinder head 10 and cylinder liner 20 and, thereby, the wear and tear of the O-rings may be reduced. The clearance may be within the range of 0.2 mm≦ΔR≦1 mm. The required tolerance of the position of centering surfaces 80A and 80B of cylinder head 10 and cylinder liner 20 may be, for example, in the range of +/−0.05 mm

The clearance may further be such that during operation of the engine, e.g. under operating temperature and the occurring large ignition pressure, a play remains to an extent that formation of frettings due to metal-metal contacts is avoided or at least reduced. In general, frettings may result in crack formations, where the cracks may then extend through, around, and/or along the cast iron of cylinder liner 20 with time. The cracks may thus damage cylinder liner 20 and shorten its life time. Furthermore, the cracks may result, for example, in leaking of the coolant circuit.

In some embodiments, the clearance may be such that a temporarily contact and/or the corresponding contact force during the combustion process may be such that frettings can be avoided or at least reduced, thereby similarly avoiding damaging cylinder liner 20 and extending its life time.

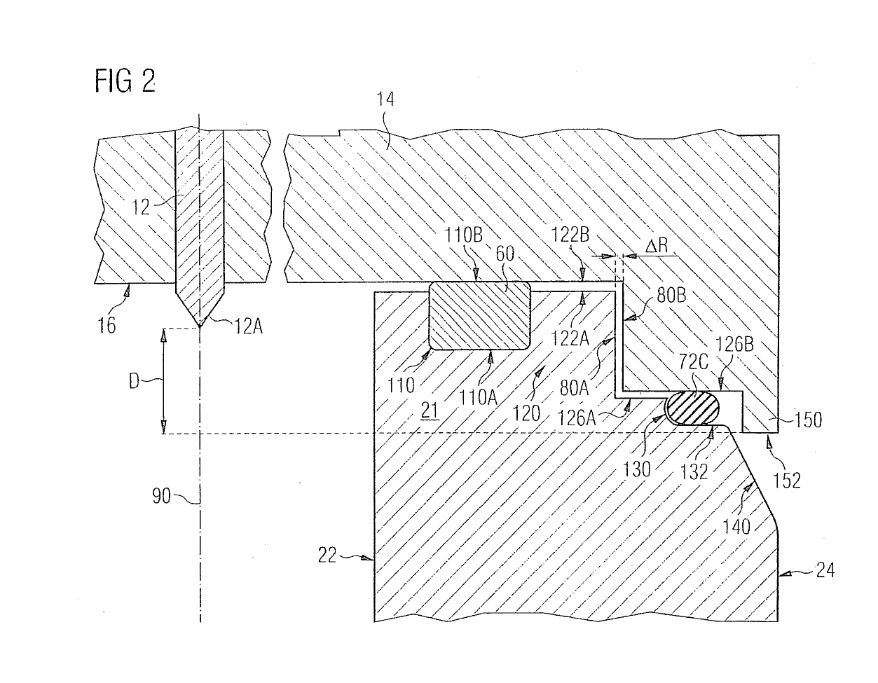

To provide for the various aspects, the metallic centering surface, the O-ring mounting surface, and the chamfered edge may form a step-like shaped cylinder liner surface. FIG. 2 illustrates an exemplary step-like structure for a section of a cylinder liner wall 21 having a liner end face that faces cylinder head 10 in the mounted state.

Specifically, FIG. 2 shows an enlarged step-like interface between cylinder head 10 and cylinder liner 20 as indicated in FIG. 1 with reference numeral II.

Specifically, the end face of cylinder liner 10 may include—in radial direction from the inside to the outside—a sealing groove 110 for joint ring 60 providing radial sealing, an alignment projection 120 with metallic centering surface 80A facing radially to the outside, a recessed face 130 facing radially to the outside and configured for holding coolant sealing O-ring 72C, and a chamfered edge 140 facing the outside.

In general liner 20 may comprise an inner liner face 22 for guiding a piston 23 of the internal combustion engine. Inner liner face 22 may extend along cylinder axis 90. Liner 20 may further comprise an outer liner face 24 and a liner end face facing in the mounted state cylinder head 10. Liner 20 has a radial thickness, i.e. a radial extension of cylinder liner wall 21 of about 30 mm to 70 mm at the cylinder head side and 15 mm to 60 mm at the crankshaft side.

The liner end face may connect inner liner face 22 and outer liner face 24 and include sealing groove 110 with a sealing area 110A for holding joint ring 60 and a step-like structure. The step-like structure may comprise in series a first radially extending face 122A on alignment projection 120 next to sealing groove 110, a first axially extending centering face 80A for centering liner 20 in the mounted state with respect to cylinder head 10 (liner centering face 80A may essentially face in radial direction away from cylinder axis 90), a second radially extending face 126A, axially extending, recessed face 130 for holding O-ring 72C, a third radially extending face 132, and chamfered edge 140 connecting third radially extending face 132 with outer liner face 24.

As further shown in FIG. 2, cylinder head 10 may comprise a cylinder head body 14 having a combustion zone face 16 delimiting combustion zone 50 and a ring-shaped face, which may surround combustion zone face 16 and, in the mounted state, face the liner end face.

Ring-shaped face may include a sealing area 110B for contacting joint ring 60 and a step-like counter-structure opposing the step-like structure of cylinder liner 20.

The step-like counter-structure may comprise in series a first radially extending cylinder head face 122B next to sealing area 110B, head centering face 80B for centering liner 20 in the mounted state with respect to cylinder head 10, whereby cylinder centering face 80B may essentially face in radial direction towards cylinder axis 90.

The step-like counter-structure may comprise further a second radially extending face 126B for contacting O-ring 72C, and at the periphery of the ring face border enhancement 150 opposing recess face 130 and potentially some section of chamfered edge 140.

Border enhancement 150 may extend beyond combustion zone face 16 further than mounted injection nozzle 12 extends beyond combustion zone face 16 in the mounted state. For example, as indicated in FIG. 2, a difference D in the range of about 5 mm or more, for example, 10 mm, or at least 15 mm may be provided in axial direction between a tip 12A of mounted injection nozzle 12 and a resting area 152 of border enhancement 150, on which cylinder head 10 rests when it is demounted from engine block 40.

In the configuration disclosed in FIG. 2, the radial sealing with joint ring 60 may be less sensitive to frettings as (metallic) centering surfaces 80A and 80B may provide tight alignment. Accordingly, a sealed mounting can be achieved with a reduced relative motion of cylinder liner 20 with respect to cylinder head 10 during engine operation, thereby reducing the wear and tear of O-rings 72A, 72B, and 72C and improving the life line of the sealing for the coolant circulation space.

### INDUSTRIAL APPLICABILITY

When assembling a cylinder unit, cylinder liner 20 may be inserted into engine block 40. Joint ring 60 may be positioned in sealing groove 110 and O-ring 72C may be positioned at recessed face 130. In addition, bolts may be prepared in engine block 40.

Coolant jacket 30 may then be put over cylinder liner such that the bolts reach through the through holes within coolant jacket 30. At the same time, O-ring 72B may be positioned at a lower end of coolant jacket 30.

Cylinder head 10 may then be prepared for being put on top of cylinder liner 20. For example, nozzle 12 may be pre-mounted to cylinder head 10 such that its tip 12A may reach beyond combustion zone face 16 for several centimeters. Cylinder head 10 may then be put onto cylinder liner 20 such the lower end of cylinder head 10 is within coolant jacket 30 and the bolts extending being coolant jacket 30 reach through through-holes 42 within cylinder head 10. At the same time, O-ring 72A may be positioned at an upper end of coolant jacket 30, thereby sealing coolant circulation space 70.

The relative position of cylinder head 10 and cylinder liner 20 may be provided by centering faces 80A and 80B, thereby avoiding or at least reducing any relative motion between cylinder head 10 and cylinder liner 20 as well as coolant jacket 30.

In the mounted state, sealing area 110B may contact joint ring 60 at the top side while sealing area 110A may contact joint ring 60 at the bottom side. When tightening cylinder head nuts on the bolts, joint ring 60 may be deform and thereby create a gas tight sealing between cylinder head 10 and cylinder liner 20.

The demounting of the cylinder unit maybe performed accordingly in reversing the above steps. In case cylinder head 10 may be stored while having nozzle 12 being mounted therein, cylinder head 10 may be positioned on any (to some extend smooth) surface using resting face 152. Accordingly, due to difference D in height, nozzle 12 may not contact the surface and, thus, be protected from any damages while being stored in a simple manner, for example, without the need of taking specific precautions with respect to protecting nozzle 12.

The above disclosed configuration of a cylinder head/cylinder liner interface may be applied to internal combustion engines in in-line configuration and in V-configuration. Examples of internal combustion engines for the herein disclosed configuration of a cylinder unit include medium speed internal combustion diesel engines, like inline and V-type engines of the series M20, M25, M32, M43 manufactured by Caterpillar Motoren GmbH & Co. KG, Kiel, Germany, operated in a range of 500 to 1000 rpm.

Herein, the term “internal combustion engine” may refer to internal combustion engines which may be used as main or auxiliary engines of stationary power providing systems such as power plants for production of heat and/or electricity as well as in ships/vessels such as cruiser liners, cargo ships, container ships, tankers, and other vehicles. Fuels for internal combustion engines may include diesel oil, marine diesel oil, heavy fuel oil, alternative fuels or a mixture thereof, and natural gas.

In some embodiments, an O-ring mounting surface for mounting an O-ring between the cylinder liner and the cylinder head for sealing any coolant from entering may be positioned radially outside of the centering surfaces. Thus, the O-ring may be subjected to a reduced temperature. In addition, a chamfered edge of the cylinder liner outer surface may allow cooling the O-ring by the coolant more efficiently. The chamfered edge may provide, for example, for a circular opening having a width in the range of 2 mm to 30 mm, for example, 5 mm to 20 mm.

In some embodiments, at the circumference, the cylinder head may be shaped to include a protection ring that extends, for example, circularly around the main body of the cylinder head. For example, the protection ring may extend for about 5 mm to 20 mm below the combustion chamber closing area of the cylinder head-within which the nozzle is mounted. The protection ring may be a closed ring or a series of ring segments of, for example, an azimuthal angular range of about, for example, 10°, 20°, or 30°. Thereby, the protection ring may protect the nozzle of the cylinder head when demounted from the engine block/cylinder liner.

In some embodiments, the inner opening diameter of cylinder liner 20 may be within the range of 200 mm to 500 mm and the thickness of liner wall 21 at a cylinder head side of cylinder liner 20 may be within the range of 30 mm to 100 mm.

In some embodiments, sealing groove 110 may be configured to extend within the inner 50% of the thickness of liner wall 21 circularly around cylinder axis 90 and may comprise liner sealing area 110A to have a width in the range of 10 mm to 40 mm in radial direction.

In some embodiments, first axially extending liner face 80A may be located at a radial position such that at least 50%, 60%, or 70% of the thickness of liner wall 21 separate first axially extending face 80A from inner liner face 22 in radial direction.

In some embodiments, first axially extending liner face 80A may extend for at least 3 mm, for example, 5 mm, 10 mm, 15 mm, 20 mm, or more in axial direction.

In some embodiments, second axially extending liner face 130 may be located at a radial position such that at least 60%, 70%, or 80% of the thickness of the liner wall separate second axially extending liner face 130 from inner liner face 22 in radial direction.

In some embodiments, transition liner face 140 may extend over a range of about 20%, 15%, 10%, or less of the thickness of liner wall 21 from outer liner face 24 to third radially extending liner face 132.

In some embodiments, cylinder head sealing area 110B may be configured to extend circularly around cylinder axis 90 and to have a width in the range of 10 mm to 40 mm in radial direction.

In some embodiments, first axially extending cylinder head face 80B may extend for at least 3 mm, for example, 5 mm, 10 mm, 15 mm, 20 mm, or more in axial direction.

In some embodiments, border enhancement 150 may extend for at least 4 mm, for example, 5 mm, 10 mm, 20 mm, 30 mm, 50 mm, or more in axial direction and resting face 152 may have a width in the range of 5 mm to 20 mm in radial direction.

In some embodiments, resting face 152 may extend at least about 5 mm, for example, 10 mm or at least 15 mm or more beyond combustion zone face 150.

Although the preferred embodiments of this invention have, been described herein, improvements and modifications may be incorporated without departing from the scope of the following claims.

1. A cylinder liner for being mounted to a cylinder head of an internal combustion engine, the cylinder liner comprising:
an inner liner face for guiding a piston of the internal combustion engine, the inner liner face extending along a cylinder axis of the cylinder liner;
an outer liner face; and
a liner end face facing the cylinder head in a mounted state and connecting the inner liner face and the outer liner face, the liner end face including a sealing groove for holding a joint ring and a step-like structure formed in a liner wall of the cylinder liner, wherein the step-like structure includes in series
a first radially extending liner face next to the sealing groove
a first axially extending liner face for centering the cylinder liner in the mounted state with respect to the cylinder head, the first axially extending liner face facing in a radial direction away from the cylinder axis,
a second radially extending liner face,
a second axially extending liner face for positioning an O-ring,
a third radially extending liner face, and
a transition liner face connecting the third radially extending liner face with the outer liner face.

2. The cylinder liner of claim 1, wherein an inner opening diameter of the cylinder liner is between 200 mm and 500 mm and a thickness of the liner wall at a cylinder head side of the cylinder liner is between 30 mm to and 100 mm.

3. The cylinder liner of claim 2, wherein the sealing groove is configured to extend within an inner 50% of the thickness of the liner wall circularly around the cylinder axis and includes a liner sealing area having a width between 10 mm and 40 mm in the radial direction.

4. The cylinder liner of claim 2, wherein the first axially extending liner face is located at a radial position such that at least 50% of the thickness of the liner wall separate the first axially extending face from the inner liner face in the radial direction.

5. The cylinder liner of claim 1, wherein the first axially extending liner face extends for at least 3 mm in an axial direction.

6. The cylinder liner of claim 2, wherein the second axially extending liner face is located at a radial position such that at least 60% of the thickness of the liner wall separate the second axially extending liner face from the inner liner face in the radial direction.

7. The cylinder liner of claim 1, wherein the transition liner face extends over a range of 20% or less of the thickness of the liner wall from the outer liner face to the third radially extending liner face.

8. A cylinder head for connecting to a cylinder liner of an internal combustion engine, the cylinder head comprising a cylinder head body having a combustion zone face delimiting a combustion zone and a ring face, which surrounds the combustion zone face and faces in a mounted state towards the cylinder liner,
wherein the ring face includes a cylinder head sealing area for contacting in the mounted state a joint ring and a step-like counter-structure, wherein the step-like counter-structure includes in series
a first radially extending cylinder head face next to the cylinder head sealing area,
a first axially extending cylinder head face for centering the liner in the mounted state with respect to the cylinder head, the first axially extending cylinder head face facing in a radial direction towards the cylinder axis,
a second radially extending cylinder head face for contacting an O-ring in the mounted state, and
a border enhancement at a periphery of the ring face that extends beyond the combustion zone face further than a mounted injection nozzle extends beyond the combustion zone face.

9. The cylinder head of claim 8, wherein the cylinder head sealing area is configured to extend circularly around a cylinder axis and has a width between 10 mm and 40 mm in the radial direction.

10. The cylinder head of claim 8, wherein the first axially extending cylinder head face extends for at least 3 mm in an axial direction.

11. The cylinder head of claim 8, wherein the border enhancement extends for at least 4 mm in an axial direction and includes a resting face having a width between 5 and 20 mm in the radial direction.

12. The cylinder head of a claim 11, wherein the resting face extends at least about 5 mm beyond the combustion zone face.

13. The cylinder head of claim 8, wherein the border enhancement extends in a ring-shape or includes a series of ring segments.

14. An internal combustion engine comprising:
an engine block,
a cylinder liner having a first axially extending liner face for centering the cylinder liner in a mounted state,
a cylinder head having a first axially extending cylinder head face for interacting with the first axially extending liner face and centering the cylinder liner in the mounted state with respect to the cylinder head,
a joint ring for providing for a radial sealing between the cylinder liner and the cylinder head, and
a coolant jacket configured to surround the cylinder liner and the cylinder head and to form a coolant circulation space between the coolant jacket, and the cylinder liner, and the cylinder head,
wherein the cylinder head and the coolant jacket include one or more though holes and the cylinder head is screwed to the engine block via one or more bolts in the through holes, thereby pressing the joint ring and the cylinder liner towards the engine block and providing a gas sealing between the cylinder liner and the cylinder head, whereby a translational movement of the cylinder liner with respect to the cylinder head is limited through the first axially extending liner face and the first axially extending cylinder head face.

15. The internal combustion engine of claim 14, wherein the first axially extending liner face and the first axially extending cylinder head face are positioned with respect to a cylinder liner axis to provide a clearance between 0.2 mm and 1 mm.

16. The internal combustion engine of claim 14, wherein:
the first axially extending liner face extends for at least 3 mm in an axial direction; and
the first axially extending cylinder head face extends for at least 3 mm in the axial direction.

17. The internal combustion engine of claim 14, wherein the cylinder liner further includes:
an inner liner face for guiding a piston of the internal combustion engine, the inner liner face extending along a cylinder axis of the cylinder liner;
an outer liner face; and
a liner end face facing the cylinder head in a mounted state and connecting the inner liner face and the outer liner face, the liner end face including a sealing groove for holding a joint ring and a step-like structure formed in a liner wall of the cylinder liner, wherein the step-like structure includes in series
a first radially extending liner face next to the sealing groove,
the first axially extending liner face, wherein the first axially extending liner face faces in a radial direction away from the cylinder axis,
a second radially extending liner face,
a second axially extending liner face for positioning an O-ring,
a third radially extending liner face, and
a transition liner face connecting the third radially extending liner face with the outer liner face.

18. The internal combustion engine of claim 17, wherein:
an inner opening diameter of the cylinder liner is between 200 mm and 500 mm;
a thickness of the liner wall at a cylinder head side of the cylinder liner is between 30 mm and 100 mm; and
the sealing groove is configured to extend within an inner 50% of the thickness of the liner wall circularly around the cylinder axis and includes a liner sealing area having a width between 10 mm and 40 mm in the radial direction.

19. The internal combustion engine of claim 14, wherein the cylinder head further includes a cylinder head body having a combustion zone face delimiting a combustion zone and a ring face, which surrounds the combustion zone face and faces in the mounted state towards the cylinder liner,
wherein the ring face includes a cylinder head sealing area for contacting in the mounted state a joint ring and a step-like counter-structure, wherein the step-like counter-structure includes in series
a first radially extending cylinder head face next to the cylinder head sealing area,
the first axially extending cylinder head face, wherein the first axially extending cylinder head face faces in a radial direction towards the cylinder axis,
a second radially extending cylinder head face for contacting an O-ring in the mounted state, and
a border enhancement at a periphery of the ring face that extends beyond the combustion zone face further than a mounted injection nozzle extends beyond the combustion zone face.

20. The internal combustion engine of claim 19, wherein:
the cylinder head sealing area is configured to extend circularly around a cylinder axis and has a width between 10 mm and 40 mm in the radial direction;
the first axially extending cylinder head face extends for at least 3 mm in an axial direction;
the border enhancement extends for at least 4 mm in the axial direction and includes a resting face having a width between 5 and 20 mm in the radial direction;
the resting face extends at least 5 mm beyond the combustion zone face; and
the border enhancement extends in a ring-shape or includes a series of ring segments.
